(19) United States
(12) Patent Application Publication
(10) Pub. No.: US 2013/0097001 A1
(43) Pub. Date: Apr. 18, 2013

(54) DYNAMIC LOYALTY SERVICE

(71) Applicants: Matthew Graham Dyor, Bellevue, WA (US); David Raskino, Kirkland, WA (US); Karthik Thirumalai, Sammamish, WA (US)

(72) Inventors: Matthew Graham Dyor, Bellevue, WA (US); David Raskino, Kirkland, WA (US); Karthik Thirumalai, Sammamish, WA (US)

(73) Assignee: Microsoft Corporation, Redmond, WA (US)

(21) Appl. No.: 13/273,238

(22) Filed: Oct. 14, 2011

(51) Int. Cl. G06Q 30/02

(52) U.S. Cl. 705/14.25

(57) ABSTRACT

A dynamic loyalty service system allows a product provider to create a demand plan that identifies anticipated demand for a service over a number of time segments. The dynamic loyalty service system generates the demand plan using information about historic commercial data about the service and historic patterns of usage of the product by the provider's loyalty program participants. The dynamic loyalty service system allows a user to identify targets for the various time segments, wherein the targets specify desired adjustments to the demand during the respective time segment. The dynamic loyalty service system uses the demand plan and the adjustment targets to generate a communication plan that specifies the messages to be sent to the provider's loyalty program participants and the communication modality for delivering the messages.

### BACKGROUND

Retail and service establishments, such as restaurants and hotels, have loyalty programs that are designed at least partially to increase revenue from loyal customers. For example, a coffee shop may provide a loyalty program in which a customer receives a free drink after buying nine drinks at regular price over a period of time, with the expectation that the promise of a free drink will cause the buyer to be loyal to that coffee shop and incentivize the buyer to purchase more drinks Such loyalty programs are implemented using punch cards, swipe cards, etc. However, these loyalty programs are static in that they fail to accommodate real-time variations in the establishment's business, real-time variations in the customers' behavior and/or to leverage the capabilities of modern day communication devices. Some loyalty programs allow users to select a preferred communication channel. However, such loyalty programs do not consider dynamic changes in objectives of a business establishment or dynamic changes in the status of loyalty program participants.

### SUMMARY

Implementations described herein address the foregoing problems by providing a dynamic loyalty service system that allows a loyalty service provider, such as a restaurant operator, to generate a demand plan for the loyalty service based on historic commercial data and/or real-time commercial data about the establishment and the loyalty program participants. The dynamic loyalty service system further determines targets used to adjust the anticipated demand or anticipated utilization rates during various segments of time (e.g., breakfast, lunch, dinner, weekends, etc.). After determining the targets to adjust the actual demand or actual utilization rates, the dynamic loyalty service system generates a communication plan to communicate a promotion to the loyalty program participants. The promotion is intended to induce the loyalty program participants to purchase an associated good or service (collectively referred to herein as a “product”) provided by the loyalty service provider during a particular time segment. The dynamic loyalty service system generates the promotion such that, when implemented, the communication plan influences the anticipated demand to approach a defined target. Further, the communication plan can be adjusted dynamically based on real-time changes in the targets, the establishment's commercial data, and the loyalty program participants' data.

In some implementations, articles of manufacture are provided as computer program products. One implementation of a computer program product provides a tangible computer program storage medium readable by a computing system and encoding a processor-executable program. Other implementations are also described and recited herein.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates example data sources and flows for a dynamic loyalty service system.

FIG. 2 illustrates example data sources and flows for a dynamic loyalty service system.

FIG. 3 illustrates example operations for providing dynamic loyalty services.

FIG. 4 illustrates alternative example operations for providing dynamic loyalty services.

FIG. 5 illustrates example communication value graphs used for generating a communication plan.

FIG. 6 illustrates an example system that may be useful in implementing the described technology.

### DETAILED DESCRIPTION

A dynamic loyalty service system disclosed herein allows a loyalty service provider to create a demand plan that identifies anticipated demand or anticipated utilization rates (customers, revenues, profits, etc.) for a good or service (collectively, “product”) over a number of time segments. The dynamic loyalty service system generates the demand plan using information about historic commercial data about the product and historic patterns of usage of the product by a vendor's loyalty program participants. The dynamic loyalty service system allows a user to identify targets for the various time segments, wherein the targets specify desired adjustments to the anticipated demand during a future time segment. The dynamic loyalty service system uses the demand plan and the adjustment targets to generate a communication plan that specifies the messages to be sent to the vendor's loyalty program participants and the communication modality for delivering the messages.

For example, a restaurant manger may use the dynamic loyalty service system to generate a demand plan specifying anticipated demand for various meals over a period of a week, identify how the restaurant operator would like to change the demand by providing targets that specify desired adjustments to the actual demand, and generate a communication plan to communicate promotions to customers. The dynamic loyalty service system also allows the restaurant operator to update the communication plan based on real time data, such as actual demand, proximity of a loyal customer, comparative profitability of the restaurant meals during various time segments, etc.

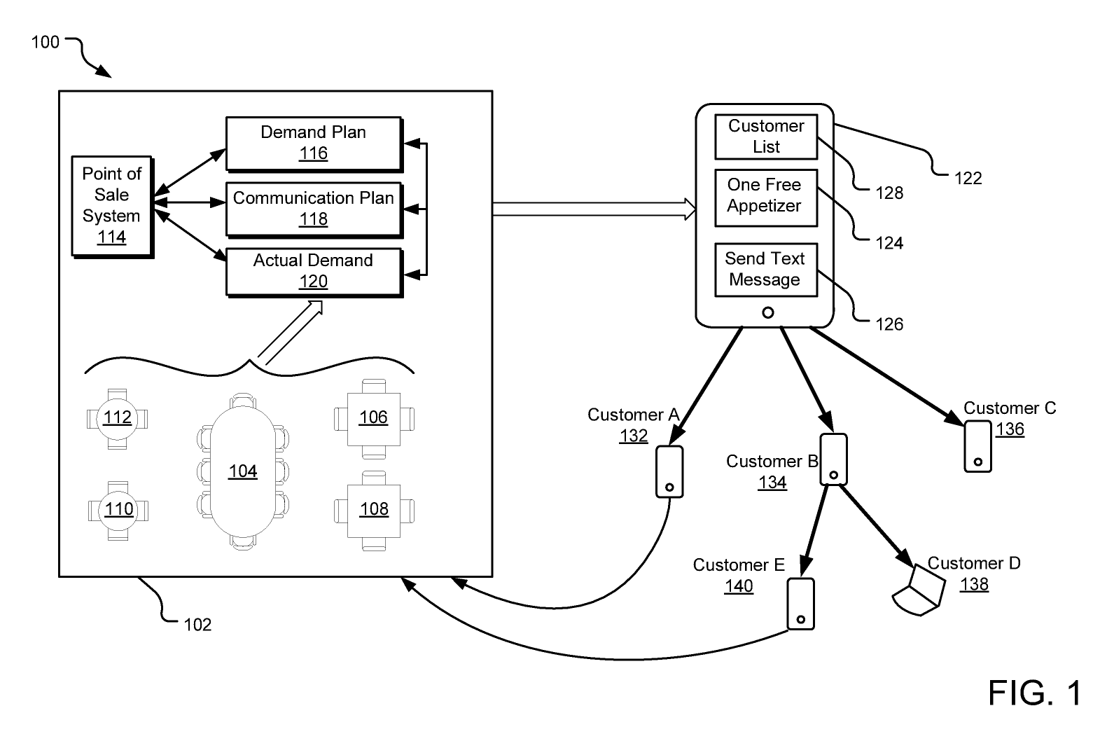

FIG. 1 illustrates example data sources and flows for a dynamic loyalty service system 100. While the dynamic loyalty service system 100 is disclosed in the context of a restaurant 102, in an alternative implementation, the dynamic loyalty service system 100 can also be used for other product providers, such as retail establishments, entertainment service providers, etc. The establishment employing the dynamic loyalty service system 100 is a restaurant 102 that serves customers at service tables 104-112. The restaurant 102 uses a point of sale system 114 to process commercial transactions with the customers of the restaurant 102. In one implementation, the point of sale system 114 is implemented using a computer that is able to collect data about the commercial transactions, such as the time of service, the meal purchased, the cost of meal, the purchaser of the meal, etc., in a database.

The dynamic loyalty service system 100 generates a demand plan 116 that describes the anticipated demand for the restaurant over a future time period. For example, the demand plan 116 describes the anticipated number of customers for the restaurant 102 over a period of a week, as based on information provided by the restaurant operator, manager, or parent corporation. In one implementation, the demand plan 116 provides the anticipated demand for each of a breakfast, a lunch, and a dinner. The dynamic loyalty service system 100 generates the demand plan 116 based on the historic commercial data about the restaurant's meal service, although other data may be used to generate the demand plan 116. For example, the demand plan 116 receives the historic commercial data about the restaurant's meal service from the point of sale system 114. Alternatively, the dynamic loyalty service system 100 also uses data about the restaurant's loyalty program participants in generating the demand plan 116.

Based on the demand plan 116, the dynamic loyalty service system 100 identifies targets for various time segments, where the targets enumerate the number of loyal customers that need to be contacted. For example, if the demand plan 116 identifies that the restaurant 102 is very busy during the dinner on Friday, no communication should be sent to any loyal customers, therefore, the target number for the Friday night dinner is zero. On the other hand, if the demand plan 116 identifies that the restaurant 102 is not very busy for the Saturday breakfast, the dynamic loyalty service system 100 sets a target of communicating with five loyal customers with promotions for the Saturday breakfast to increase the customer traffic for the Saturday breakfast.

The dynamic loyalty service system 100 uses the targets and the demand plan 116 to generate a communication plan 118 that specifies in advance what messages are to be sent to which loyal customers. In one implementation, such loyal customers include various participants of the restaurant's loyalty program. The communication plan 118 provides various information about communicating with such customers, including what message is to be sent to which customer, which modality/channel are to be used to communicate with a particular customer, etc.

For example, if customer Joe has shown preference for receiving text messages over receiving e-mails, the communication plan 118 recommends communicating with Joe using text messages. On the other hand, if the historic datastore suggests that customer Bob always responds positively to a message on Twitter™, the communication plan 118 recommends generating a Twitter™ message to communicate with Bob. The communication plan 118 also specifies which customer to communicate with during which time segment. For example, if customer Mary has been a regular customer for breakfast but not for dinners, the communication plan 118 specifies that special promotions for dinners be communicated to Mary.

In one implementation, the demand plan 116 and the communication plan 118 are able to receive real-time information, such as actual demand 120. The point of sale system 114 provides the information about the number of customers in the restaurant 102 during the current time segment, the sales for the current time segment, the profitability of various items sold during the current time segment, etc., as part of the actual demand 120. The communication plan 118 updates the recommended promotions and communication messages based on such information about the actual demand 120. For example, if the actual demand suggests that a special dish made by the chef for the current time segment is not selling, the communication plan revises the messages to be sent on Twitter™ to promote the special dish.

In an alternative implementation, the dynamic loyalty service system 100 also collects and uses other real-time information, such as weather conditions, proximity of the customers to the restaurant 102, etc., in revising the promotions and the recommendations. For example, if the dynamic loyalty service system 100 determines that customer John is near the restaurant, the dynamic loyalty service system 100 revises the communication plan 118 to generate a communication message to John to invite him for the meal during the current time segment with a promotion to entice him. Similarly, if the dynamic loyalty service system 100 receives information from a Facebook™ page of a customer that the customer is inviting his friends for drinks, the dynamic loyalty service system 100 updates the communication plan 118 to recommend sending an invitation to that customer with a promotion for a group outing to the restaurant 102.

In an implementation, a user, such as a restaurant operator, is able to make changes to the communication plan 118 in real time. For example, if the restaurant operator notices that it is difficult to find parking near the restaurant, the restaurant operator is able to add a promotion for free valet parking to the outgoing messages generated by the communication plan. Similarly, if the restaurant operator notices that certain items on the menu are not selling as well as expected and will likely be thrown away after the current meal time, the restaurant operator can add a special promotion where such items are free to customers upon their buying another item from the menu.

The dynamic loyalty service system 100 can send recommendations of various promotions to a user, such as a restaurant operator. For example, the dynamic loyalty service system 100 sends a recommendation to a smartphone 122 of the restaurant operator as a push notification, an SMS message, in response to a user launching a web page or mobile application, etc. The dynamic loyalty service system 100 generates such recommended communication messages based on the communication plan 118. Alternatively, the communication messages are generated based on the communication plan 118 as updated by a user or updated by the dynamic loyalty service system 100 based on the real-time information. In an alternative implementation, the dynamic loyalty service system 100 generates the communication messages based on the communication plan 118 and sends them directly to the customers. For example, the dynamic loyalty service system 100 automatically generates Twitter™ messages about a special dish created by the chef before a given time segment. In such a case, a user need not review the recommendations generated by the communication plan or manually send the communication messages.

FIG. 1 illustrates the dynamic loyalty service system 100 generating a recommended message 124 for “one free appetizer” on the smartphone 122. The dynamic loyalty service system 100 recommends that such a message be sent to the customers via text messaging. In such a case, the user is also provided an option 126 on the smartphone 122 that the user can select to send the recommended message 124 to customers. Furthermore, the user is also provided a customer list 128 listing the names of the customers that will receive the recommended message 124. In one implementation, the user is presented with (e.g., via a graphical user interface on a mobile application, a web page, etc.) a recommended recipient, channel, and message from the dynamic loyalty service system 100 and the user may accept the recommendation and send the message by activating a single control, such as option 126.

Another example of a recommendation generated by the dynamic loyalty service system 100 is a message that is generated in response to a piece of real-time information. For example, if the dynamic loyalty service system 100 determines that a customer has searched for a reservation at a restaurant in the vicinity of restaurant 102 in the last five minutes, the dynamic loyalty service system 100 generates a message to that particular customer offering a special discount along with information about the available seating times at the restaurant 102.

In one implementation, the user is able to change information in the recommended message 124 and the customer list 128. For example, the user can change the recommended message 124 from “one free appetizer” to “one free drink.” Further, the user can add and/or subtract names and/or phone numbers of additional customers to the customer list 128. Similarly, the dynamic loyalty service system 100 also allows the user to change the modality of the outgoing communication messages. Thus, instead of sending the recommended message 124 by text messaging, the user can post the recommended message 124 on Twitter™, Facebook™, etc.

FIG. 1 illustrates that the user sends the recommended message 124 to customers A-C, 132-136. Customer B 134 forwards the recommended message 124, or information about the recommended message 124, to additional customers D-E, 130-140. As a result of the communication to the customers A-E, 132-140, customer A 132 and customer E 140 decides to visit the restaurant 102, resulting in the actual demand at the restaurant 102 to be close to the desired demand.

While in the implementation of the dynamic loyalty service system 100 discussed in FIG. 1, the demand plan 116 describes anticipated demand by a breakfast, a lunch, and a dinner, in an alternative implementation, the anticipated demand is provided by more or less granularity. Thus, for example, in one implementation, the demand plan 116 describes the actual demand by the day, by the hour of the day, etc.

Similarly, FIG. 1 illustrates the point of sale system 114 collecting and storing historic commercial data about the restaurant 102, in an alternative implementation, the point of sale system 114 is also used to determine the actual demand 120 at the restaurant 102. Alternatively, the actual demand 120 at the restaurant 102 at any given time is determined by feedback from the restaurant operator about how many of the tables 104-112 are occupied at any given time.

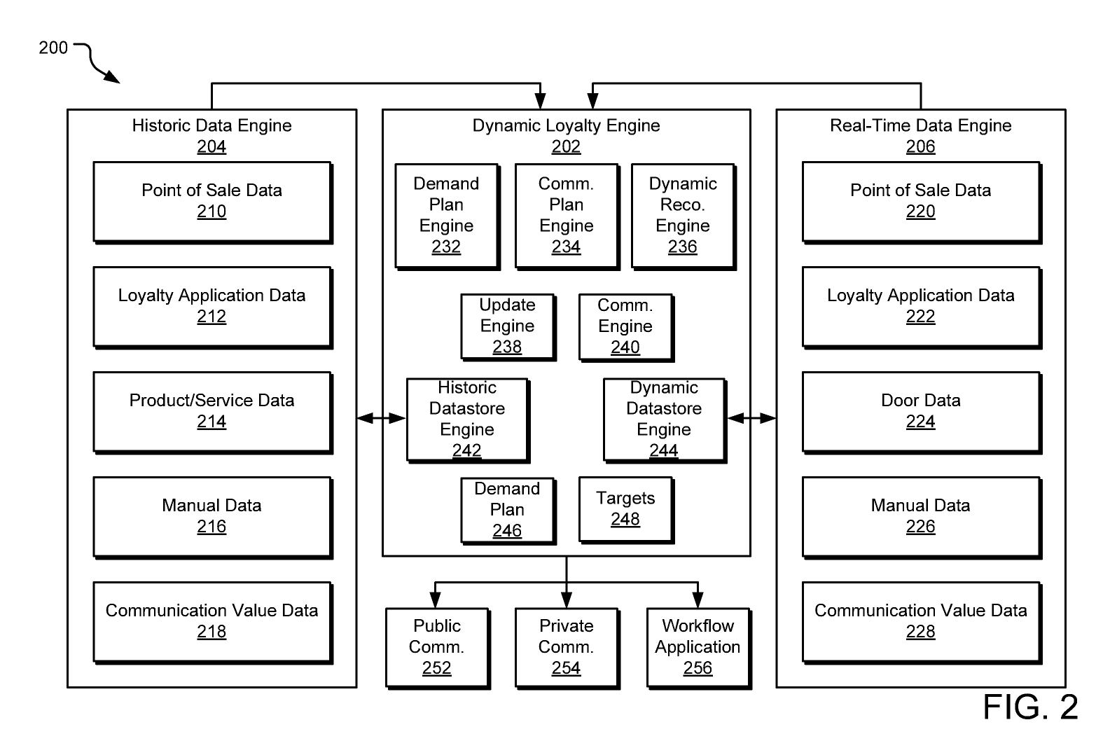

FIG. 2 illustrates example data sources and flows for a dynamic loyalty service system 200. The dynamic loyalty service system 200 includes a dynamic loyalty engine 202 that is communicatively connected to the historic datastore 204 and the real-time datastore 206. The dynamic loyalty engine 202 processes the information received from the historic datastore 204 and the real-time datastore 206 to generate a demand plan, a communication plan, an updated communication plan, and the recommendations to be sent to the user.

The historic datastore 204 collects and stores information about the past commercial transactions, the past activity of loyalty program participants, etc. For example, the historic datastore 204 collects the point of sale data 210 collected from a point of sale system for an enterprise using the dynamic loyalty service system 200. Such point of sale data 210 includes the past sales information about various products, the profitability information about such products, the information about the relation of the purchased items to customers, etc. For example, the point of sale data 210 has the information about which customer purchases products with high profit margins as well as the profit margin of the purchases for various time segments. Thus, for example, for the dynamic loyalty service system 200 used by a restaurant, the point of sale data 210 identifies that a customer A purchases the menu items with higher profit margin during a lunch compared to the menu items purchased during a dinner. The dynamic loyalty engine 202 uses such information about the comparative profit margin in generating a communication plan.

The historic datastore 204 also includes the loyalty application data 212 that collects and stores data about participants of a loyalty program. Such loyalty application data 212 include list of the loyalty program participants, their contact information, their past usage of the various products, etc. The historic datastore 204 also includes the product data 214 that lists the pricing and other information about various products offered by an enterprise using the dynamic loyalty service system 200. For example, if the enterprise using the dynamic loyalty service system 200 is a restaurant, the product data 214 will include the menu data about various meals offered by the restaurant. The manual datastore 216 stores other data that is input by a user of the dynamic loyalty service system 200, such as the personal notes about a product, the personal notes about a particular customer, etc. For example, a restaurant operator stores information about the ingredients of a special new dish in the manual datastore 216, so that such information can be used by the operator in response to questions by a customer.

The communication value data 218 stores the historic communication value of a communication to a customer. An example of such communication value data is conflict data about the conflict of a customer with a particular promotion of offer. For example, if a customer works during the evening shift job through the week, he is not likely to respond to the promotions for dinner during weekdays. In an alternative implementation, the conflict data is determined based on an output, such as a busy or available value, received from a personal calendar application (or service) of a customer. Another example of such communication value data is location data about a customer, such as the distance of a customer's residence from a restaurant and/or the current distance between the customer and the restaurant. Thus, if the customer lives quite far from the restaurant or is determined to be remote from the restaurant, he or she is not likely to respond to a short-term promotion directed to the current time segment. The location of the customer may be statically determined (e.g., residence address provided upon user registration with an application or service) and/or dynamically determined (e.g., as determined by a location aware application or service). Similarly, the reliability data stored in the communication value data 218 identifies the reliability of a customer. For example, if a customer has indicated in the past that he is going to use a promotion for dinner but did not show up for the dinner, such a customer cannot be relied upon to increase demand at a restaurant and hence he is assigned a low reliability value.

The communication value data 218 is also used for storing information about customer malleability, which captures the malleability of the customers to various offers. For example, the communication value data 218 stores information about which customers are more likely to respond to a promotion offer. For example, the communication value data 218 identifies that a customer A responds to the buy-one-get-one free offers more than fifty percent of the times by using the offer within two days of the receipt of such an offer and that in response to such an offer, the customer A also brings at least one additional customer. On the other hand, a customer B responds positively to the free drink offers but does not respond to any buy-one-get-one free offers. The dynamic loyalty engine 202 uses such information about the behavior and the malleability of customers in generating a communication plan. Fewer or additional factors may be considered in determining a communication value for a particular message.

In one implementation, the communication value data 218 includes specific purpose data, which provides information about the lifetime value of a product, a customer, a loyalty program participant, etc. For example, such specific purpose data identifies that a restaurant customer that is regular at lunches is to be offered a promotion that would attract him to dinners. Another example of the specific purpose data is information about a drink special that identifies that even though the drink itself has a negative profit margin, offering the drink increases the traffic to the restaurant, and therefore, the sale of other high profit margin items such as the desserts.

The real-time datastore 206 collects and stores real-time information about various commercial transactions, loyalty program participants, etc. For example, the point of sale data 220 collects and stores current information from a point of sale system, such as, how many services are currently being utilized. Thus, for a restaurant using the dynamic loyalty service system 200, the point of sale data 220 provides information about how many tables are currently busy, how many customers are waiting in line, etc. The point of sale data 220 also provides information about various products. Thus, for a restaurant, the point of sale data 220 provides information about how many of the menu items are still available for a given meal segment, etc. The loyalty application data 222 collects and stores the real-time information about loyalty program participants, such as how many loyalty program participants are currently in the restaurant, etc.

The door data 224 provides collects and stores real-time information about how many customers are waiting for a product. In one implementation, if the customers waiting for a product have provided their names, phone numbers, or other identifying information, the door data 224 also stores such information. Additionally, the door data 224 also includes waiting times for the customers and generates messages if a customer has waited for more than a predetermined amount of time, such as for example, more than half an hour, etc. The loyalty service system 200 uses such door data 224 to generate communications to such customers.

The real-time datastore 206 also includes manual datastore 226. Such information includes the observations about current customers, the customers waiting at the door, notes about products for the current time segment, etc. The communication value data 228 collects and stores the real-time information about the conflicts of the customers, the location of the customers and the loyalty program participants, the reliability and malleability information about the customers and the loyalty program participants, etc. For example, the communications value data 228 includes the real-time location of the customers as generated by applications such as FourSquare™, etc.

The dynamic loyalty engine 202 includes a demand plan engine 232 that generates a demand plan 246 using the data from the historic datastore 204. The demand plan 246 identifies the anticipated demand or anticipated utilization rates for various products of an enterprise using the dynamic loyalty service system 200. For example, for a restaurant using the dynamic loyalty service system 200, the dynamic loyalty engine 202 generates a demand plan 246 providing the anticipated demand for various meals over a period of a week. Such demand plan 246 is generated based on the historic commercial data, such as the data gathered from the point of sales data 210, the loyalty application data 212, etc.

A communication plan engine 234 generates a communication plan based on the demand plan 246 and targets 248 provided by a user. For example, a restaurant operator provides targets for increase in demand for each of the various meals over a period of a week. For example, if the demand plan 246 provides that for Tuesday evening dinner, the anticipated demand leaves room for five additional customers, a restaurant operator may specify a target of three, that is, to increase the number of customers for the Tuesday evening dinner by three. The communication plan engine 234 takes into consideration the demand plan 246, the targets 248, and various data from the historic datastore engine 242 to generate a communication plan specifying the promotions to be communicated to the loyalty program participants. An example of such communication plan provides for sending e-mails to ten loyalty program participants on the Tuesday morning with a promotion for half-price entrees for the Tuesday evening. The communication plan also provides for reviewing the results of the e-mail communications and based on the response, sending text messages to three additional loyalty program participants on the Tuesday afternoon with a promotion geared towards these three loyalty program participants.

Once the communication plan is generated, a dynamic recommendation engine 236 generates recommendations based on the communication plan. For example, a recommendation generated by the dynamic recommendation engine 236 provides a text message on the smartphone of a restaurant operator, requesting the restaurant operator to send text messages to five of the restaurant's loyalty program participants with a particular promotion. An update engine 238 updates the communication plan based on real-time information about the actual demand or actual utilization rates. For example, the update engine 238 updates the promotions, the channels used for communication promotions to users, etc. Thus, if the update engine 238 determines that using e-mails to send the promotions to the loyalty program participants is not working as anticipated, the update engine 238 recommends using text messages to communicate the promotions. The dynamic recommendation engine 236 uses a communication engine 240 to communicate the recommendation and/or promotions to the user. The communication engine 240 is also used by a historic datastore engine 242 to communicate with the historic datastore 204 and by a real-time datastore engine 244 to communicate with the real-time datastore 206.

Furthermore, the dynamic loyalty engine 202 uses the communication engine 240 to generate and send messages, such as text messages, Facebook™ postings, etc. The dynamic loyalty engine 202 communicates with the loyalty program participants and other customers using a number of different communication channels. For example, the dynamic loyalty engine 202 sends public communication messages through public communications channels 252 such as Facebook™, Twitter™, etc., and through private communication channels 254, such as text messages. In one implementation, the dynamic loyalty engine 202 communicates with a workflow application 256 that assists various users in planning a collection of activities. For example, such a workflow application 256 assists the users in planning an evening out with dinner and movie, in which case the workflow application 256 uses the information received from the dynamic loyalty engine 202 to generate the workflow suggestions for its users.

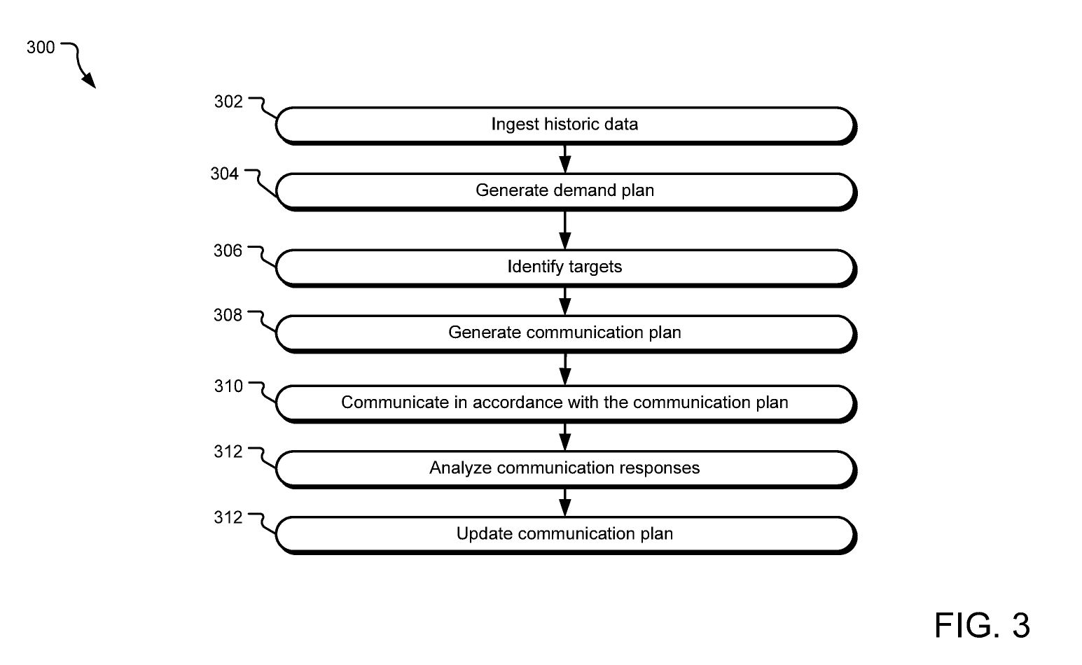

FIG. 3 illustrates the example operations 300 for providing dynamic loyalty services for an enterprise, such as a restaurant, a retail establishment, etc. An ingesting operation 302 ingests historic data, such as historic commercial data, historic data related to the enterprise's loyalty program participants and the enterprise's customers, etc. In one implementation, the ingesting operation 302 organizes such historic data and generates various data tables and relations among such data tables so that the historic data can be evaluated to determine useful information. A generating operation 304 uses the historic data to generate a demand plan providing the anticipated demand. For example, for a restaurant, the generating operation 304 provides the anticipated demand for the various meals of the restaurant over a number of time segments. An identifying operation 306 identifies various targets based on the demand plan. Such targets may provide the goals for increasing the demand for various time periods, the goals for increasing sales for various time periods, etc.

Once a demand plan is generated and the targets are received, a generating operation 308 generates a communication plan using the demand plan, the targets, and the historic data about the enterprise. Such a communication plan provides various messages, the modality of such messages, the timing of such messages, the expected response for the messages, the follow-up communications, the backup plan if the messages are not successful, etc. For example, the communication plan may provide for communicating via e-mail with a first number of loyalty program participants with a first promotion message and subsequently, based on the response to the first communication, communicating a second promotion message to a second number of customers via text messaging. A communicating operation 310 communicates in accordance with the communication plan.

An analyzing operation 312 analyzes the responses to the communications. For example, if the communication plan provides for sending e-mails to ten loyalty program participants promoting a dinner, the analyzing operation 312 determines how many of the ten loyalty program participants responded to the e-mails and/or how many of them made a reservation for the dinner. An updating operation 312 uses this information generated by the analyzing operation together with other information, such as the reliability of the loyalty program participants, the malleability of the loyalty program participants, etc., to update the communication plan.

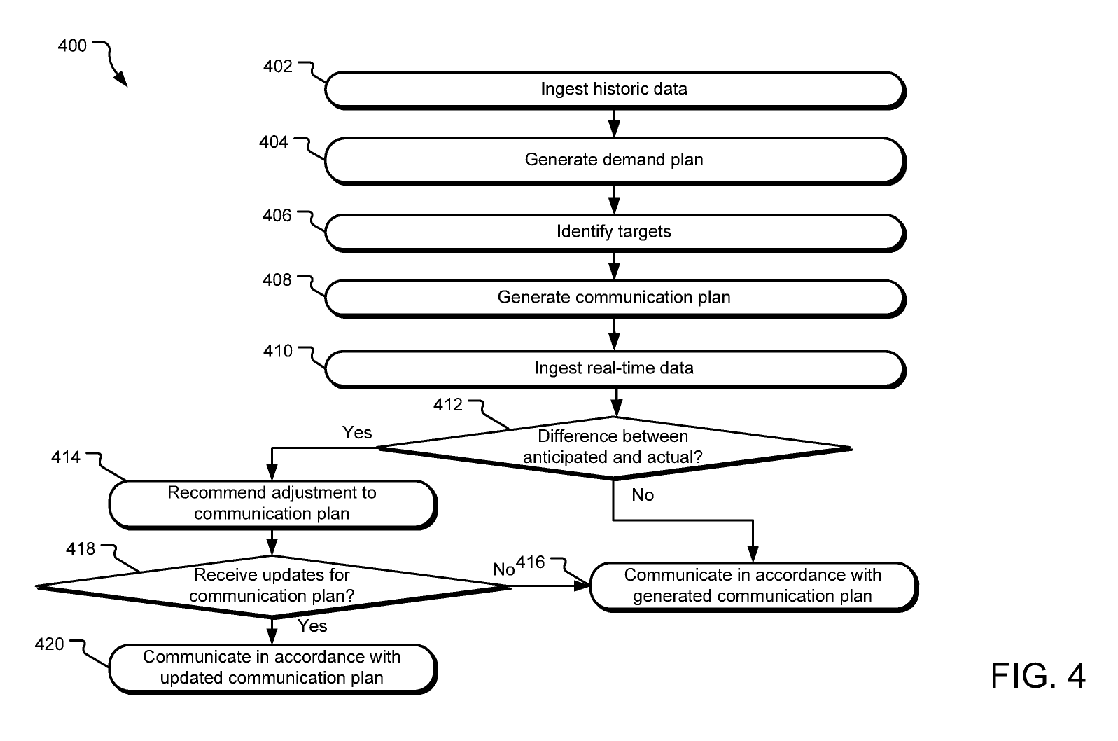

FIG. 4 illustrates the example operations 400 for providing dynamic loyalty services using real-time data. An ingesting operation 402 ingests the historic data, such as historic point of sales data, the historic loyalty program participants' data, etc., and organizes the historic data. A generating operation 404 generates a demand plan that provides the anticipated demand for a time period. For example, for a restaurant, the demand plan provides anticipated demand for breakfast, lunch, and dinner for a period of a week. An identifying operation 406 identifies the targets or the goals for achieving the desired demand. For example, the identifying operation 406 provides that for a breakfast that has anticipated revenue of only fifty percent of full-capacity revenue, the demand should be increased so as to raise the revenue to seventy-five percent of the full-capacity revenue.

A generating operation 408 generates a communication plan using the demand plan, the targets, and other historic data. Such a communication plan provides for the content and modality of the communications to be sent to potential customers and the selected loyalty program participants to increase the anticipated demand for an enterprise. After generating the communication plan, an ingesting operation 410 ingests dynamic or real-time data that may affect the communication plan and/or the enterprise using the communication plan. For example, such real-time data includes the real-time data obtained from a point of sales system, the data obtained from the Internet, such as the weather data, etc.

An evaluating operation 412 evaluates the differences between the demand plan and the actual demand. For example, if the demand plan suggests having ten customers while there are only two customers present, the evaluating operation suggests that there are significant differences between the anticipated and the actual demand. In such a case, a recommending operation 414 recommends adjustments to the communication plan. Similarly, for example, if the actual demand is much higher than the anticipated demand, the recommendation operation 414 recommends adjustments to the communication plan. However, if the actual demand is close to the anticipated demand, for example having ten customers when the user anticipated having eleven customers, a communications operation 416 communicates in accordance with the communication plan.

If the communication plan is to be adjusted as per the recommending operation 414, a determining operation 418 determines if any updates are received for the communication plan. An example of such an update is to post a Twitter™ messages promoting a special deal, etc. If no such updates are received, the communications operation 416 communicates in accordance with the communication plan. However, if the communication plan is updated, a communication operation 420 communicates in accordance with the updated communication plan.

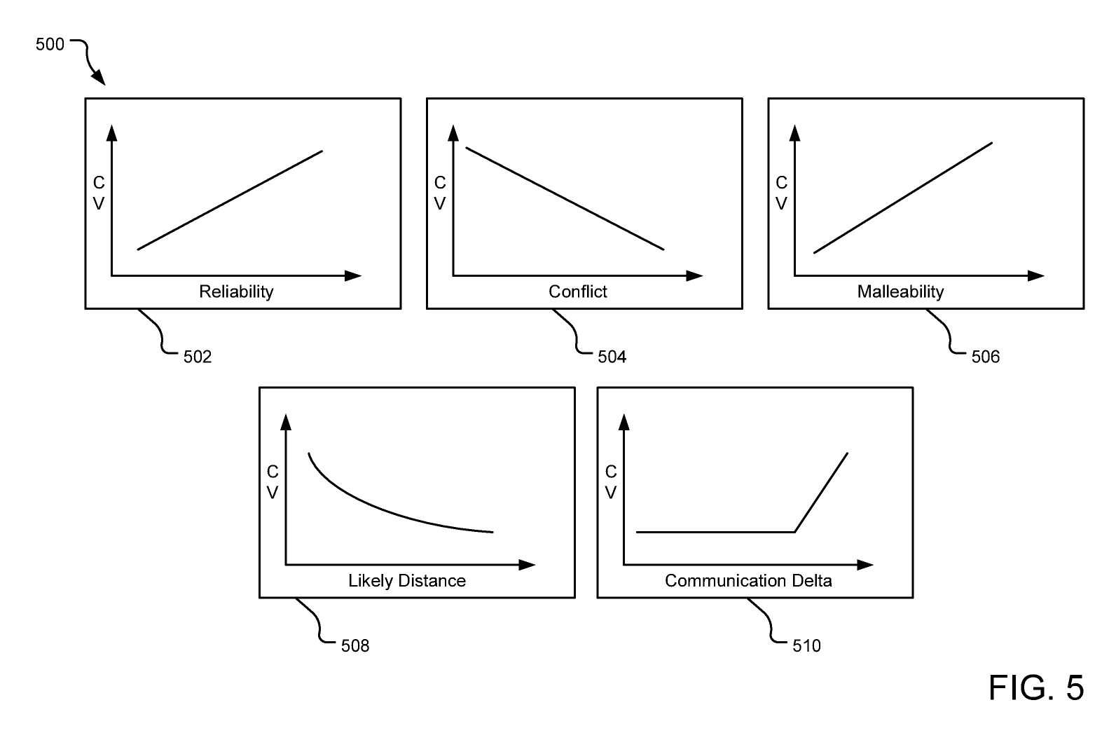

FIG. 5 illustrates example communication value graphs 500 used for generating a communication plan. Each of the communication value graphs 500 depicts a relation between the communication value (CV) of a communication, such as a text message and a variable related to a communication receiver, such as a loyalty program participant. For example, the communication value graph 502 illustrates that the relation between reliability of a receiver and the communication value has a positive slope, that is, as the reliability value of the receiver increases, the communication value of a message sent to such receiver also increases. Note that even though the relationship in the communication value graph 500 is illustrated to be a linear function, in practice the relation can be of illustrated by a different function such as a concave function, a step function, a combination of a step and a linear function, etc.

The communication value graph 504 illustrates the relation between CV and conflict value. As illustrated in the graph 504, as the conflict value for the receiver increases, the CV of a message sent to that receiver decreases. Similarly, the communication value graph 506 illustrates that if the receiver is highly malleable, i.e., if the receiver's action is likely to be changed by sending a communication message, the CV of the message will be higher. The relation between the likely distance and CV, as illustrated by the communication value graph 508, has a negative slope. In this case, if the receiver is further away from a restaurant, sending messages to that receiver is not likely to increase the likelihood of the receiver to purchase any products at the restaurant. Finally, the communication value graph 510 illustrates that the relation between the communication delta of a receiver, which is the time since the last communication with the receiver, and the CV is a step function. In this case if there was a communication sent to the customer recently than sending a new communication will not cause the customer to purchase any product. However, after a certain time period, such as a one-month of delta, sending a communication will have higher CV, increasing at a linear rate. In one implementation, a communication value is determined by a combination of one or more of these communication value graphs, such as an aggregate value, a weighted average, etc. Additionally or alternatively, machine learning and other forms of artificial intelligence may be employed to determine and optimize communication values.

A communication plan engine uses the relations illustrated in the communication value graphs 502-510 to generate a communication plan and to update the communication plan.

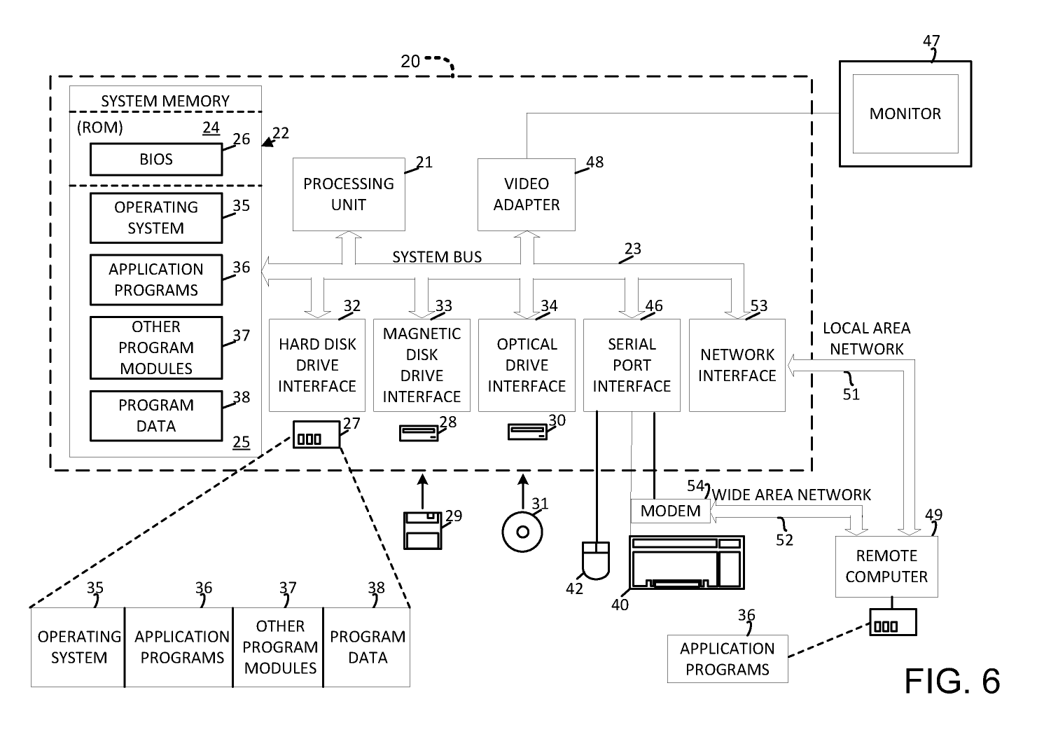

FIG. 6 illustrates an example system that may be useful in implementing the described technology. The example hardware and operating environment of FIG. 6 for implementing the described technology includes a computing device, such as general purpose computing device in the form of a gaming console or computer 20, a mobile telephone, a personal data assistant (PDA), a set top box, or other type of computing device. In the implementation of FIG. 6, for example, the computer 20 includes a processing unit 21, a system memory 22, and a system bus 23 that operatively couples various system components including the system memory to the processing unit 21. There may be only one or there may be more than one processing unit 21, such that the processor of computer 20 comprises a single central-processing unit (CPU), or a plurality of processing units, commonly referred to as a parallel processing environment. The computer 20 may be a conventional computer, a distributed computer, or any other type of computer; the invention is not so limited.

The system bus 23 may be any of several types of bus structures including a memory bus or memory controller, a peripheral bus, a switched fabric, point-to-point connections, and a local bus using any of a variety of bus architectures. The system memory may also be referred to as simply the memory, and includes read only memory (ROM) 24 and random access memory (RAM) 25. A basic input/output system (BIOS) 26, containing the basic routines that help to transfer information between elements within the computer 20, such as during start-up, is stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, random access memories (RAMs), read only memories (ROMs), and the like, may be used in the example operating environment.

A number of program modules may be stored on the hard disk, magnetic disk 29, optical disk 31, ROM 24, or RAM 25, including an operating system 35, one or more application programs 36, other program modules 37, and program data 38. A user may enter commands and information into the personal computer 20 through input devices such as a keyboard 40 and pointing device 42. Other input devices (not shown) may include a microphone, joystick, game pad, satellite dish, scanner, or the like. These and other input devices are often connected to the processing unit 21 through a serial port interface 46 that is coupled to the system bus, but may be connected by other interfaces, such as a parallel port, game port, or a universal serial bus (USB). A monitor 47 or other type of display device is also connected to the system bus 23 via an interface, such as a video adapter 48. In addition to the monitor, computers typically include other peripheral output devices (not shown), such as speakers and printers.

The computer 20 may operate in a networked environment using logical connections to one or more remote computers, such as remote computer 49. These logical connections are achieved by a communication device coupled to or a part of the computer 20; the invention is not limited to a particular type of communications device. The remote computer 49 may be another computer, a server, a router, a network PC, a client, a peer device or other common network node, and typically includes many or all of the elements described above relative to the computer 20, although only a memory storage device 50 has been illustrated in FIG. 6. The logical connections depicted in FIG. 6 include a local-area network (LAN) 51 and a wide-area network (WAN) 52. Such networking environments are commonplace in office networks, enterprise-wide computer networks, intranets and the Internet, which are all types of networks.

When used in a LAN-networking environment, the computer 20 is connected to the local network 51 through a network interface or adapter 53, which is one type of communications device. When used in a WAN-networking environment, the computer 20 typically includes a modem 54, a network adapter, a type of communications device, or any other type of communications device for establishing communications over the wide area network 52. The modem 54, which may be internal or external, is connected to the system bus 23 via the serial port interface 46. In a networked environment, program engines depicted relative to the personal computer 20, or portions thereof, may be stored in the remote memory storage device. It is appreciated that the network connections shown are example and other means of and communications devices for establishing a communications link between the computers may be used.

In an example implementation, a dynamic loyalty service engine, various applications, and other engines and services may be embodied by instructions stored in memory 22 and/or storage devices 29 or 31 and processed by the processing unit 21. A user profile, user requests, information about a user's social network, and other data may be stored in memory 22 and/or storage devices 29 or 31 as persistent datastores. Further, a dynamic loyalty service engine represents hardware and/or software configured to provide service functionality for network-connected systems. Such services may be implemented using a general purpose computer and specialized software (such as a server executing service software), a special purpose computing system and specialized software (such as a mobile device or network appliance executing service software), or other computing configurations.

The embodiments of the invention described herein are implemented as logical steps in one or more computer systems. The logical operations of the present invention are implemented (1) as a sequence of processor-implemented steps executing in one or more computer systems and (2) as interconnected machine or circuit engines within one or more computer systems. The implementation is a matter of choice, dependent on the performance requirements of the computer system implementing the invention. Accordingly, the logical operations making up the embodiments of the invention described herein are referred to variously as operations, steps, objects, or engines. Furthermore, it should be understood that logical operations may be performed in any order, unless explicitly claimed otherwise or a specific order is inherently necessitated by the claim language.

The above specification, examples, and data provide a complete description of the structure and use of exemplary embodiments of the invention. Since many embodiments of the invention can be made without departing from the spirit and scope of the invention, the invention resides in the claims hereinafter appended. Furthermore, structural features of the different embodiments may be combined in another embodiment without departing from the recited claims.

What is claimed:

1. A method comprising:
generating a demand plan based on historic commercial data about a product, the demand plan describing anticipated utilization rates for the product for a set of time segments over a future time period;
identifying a target for adjusting the anticipated demand for the product during one or more of the set of time segments of the future time period;
generating a communication plan specifying one or more promotions to be communicated to one or more of loyalty program participants and one or more channels for communicating the one or more promotions to the one or more loyalty program participants, the communication plan configured to adjust the anticipated utilization rates by the target in the future time period;
updating the one or more channels based on real-time information about actual utilization rates; and
communicating the one or more promotions in accordance with the updated communication plan.

2. The method of claim 1 wherein generating the communication plan further comprises generating the communication plan specifying the timing of communicating the one or more promotions to increase the likelihood of realizing the target.

3. The method of claim 1 wherein communicating the one or more promotions further comprising communicating the one or more promotions to the one or more of the loyalty program participants.

4. The method of claim 2 wherein updating the communication plan further comprising updating the communication plan based on measurable real-time data stored in a real-time datastore.

5. The method of claim 4 wherein updating the communication plan further comprises updating at least one of the specified one or more promotions, the specified channels, and the specified one or more loyalty program participants.

6. The method of claim 4 wherein the real-time information comprises locations of the one or more of the loyalty program participants.

7. The method of claim 4 wherein the real-time information comprises at least one of (1) a calendar information about the one or more of the loyalty program participants; and (2) conflict information about the one or more of the loyalty program participants.

8. The method of claim 4 wherein the real-time information comprises search requests for the product by the one or more of the loyalty program participants.

9. The method of claim 4 wherein the real-time information comprises time elapsed since last purchase of the product by the one or more of the loyalty program participants.

10. The method of claim 1 wherein the historic commercial data comprises historic purchase patterns of the loyalty program participants for the product.

11. The method of claim 1 wherein the historic commercial data comprises information about the profitability of the product for during the one or more time segments.

12. The method of claim 1 wherein the product comprises a sale of a service.

13. One or more tangible computer-readable storage media storing computer executable instructions for performing a computer process on a computing system, the computer process comprising:
generating a demand plan based on historic commercial data about a product and historic data about the product's loyalty program participants, the demand plan describing anticipated utilization rates for the product over a future time period;
identifying a target for adjusting the anticipated demand for the product during one or more time segments of the future time period;
generating a communication plan specifying one or more promotions to be communicated to one or more of loyalty program participants, the communication plan configured to adjust the anticipated utilization rates by the target in the future time period, and updating the communication plan based on real-time information about actual utilization rates.

14. The one or more tangible computer-readable storage media of claim 13 wherein generating a communication plan further comprising selecting the one or more of the loyalty program participants based on value of a variable related to the one or more of the loyalty program participants.

15. The one or more tangible computer-readable storage media of claim 14 wherein the variables include at least one of (1) reliability of the one or more of the loyalty program participants; (2) likely distance of the one or more of the loyalty program participants; (3) communication delta of the one or more of the loyalty program participants; and (4) conflict of the one or more of the loyalty program participants.

16. The one or more tangible computer-readable storage media of claim 13 further comprising:
updating the communication plan based on real-time information about actual demand;
generating an adjusted promotion based on the updated communication plan; and
communicating the adjusted promotion to the one or more of the loyalty program participants.

17. The one or more tangible computer-readable storage media of claim 16 further comprising:
communicating the one or more promotions and information identifying the one or more of the loyalty program participants to a first communication device;
modifying at least one of the one or more promotions and the information identifying the one or more of the loyalty program participants using the first communication device; and
communicating the modified promotion to the one or more of the loyalty program participants using the first communication device.

18. A dynamic loyalty product system, comprising:
a demand plan engine adapted to generate a demand plan based on historic commercial data about a product, the demand plan describing anticipated utilization rates for the product over a future time period;
a communication plan engine adapted to generate a communication plan to communicate one or more promotions to one or more of loyalty program participants, the communication plan configured to adjust the anticipated utilization rates by a target in the future time period;
an update engine adapted to update the communication plan based on real-time information about actual utilization rates; and
a communication engine adapted to communicate the one or more promotions to the one or more of the loyalty program participants.

19. The dynamic loyalty product system of claim 18 wherein the demand plan engine is further adapted to receive the historic commercial data from a point of sale system.

20. The dynamic loyalty product system of claim 18 wherein the communication engine is further adapted to communicate the promotion to one or more loyalty program participants using a workflow application.
